(19) United States
(12) Patent Application Publication
(10) Pub. No.: US 2018/0230986 A1
(43) Pub. Date: Aug. 16, 2018

(54) DOUBLE-HEADED SWASH PLATE-TYPE COMPRESSOR

(71) Applicant: Hanon Systems, Daejeon (KR)

(72) Inventor: Min Gyu Kim, Daejeon (KR)

(21) Appl. No.: 15/578,358

(22) PCT Filed: Jul. 22, 2016
(86) PCT No.: PCT/IB2016/054375

§ 371 Date: Mar. 20, 2018

(30) Foreign Application Priority Data
Jul. 14, 2015 (KR) 10-2015-0099978

(51) Int. Cl. F04B 39/16; F04B 27/12; F04B 39/02; F04B 27/10; B01D 17/02

(52) U.S. Cl. CPC F04B 39/16; F04B 27/12; B01D 17/0217; F04B 27/109; F04B 39/0276

(57) ABSTRACT

The present invention relates to a double-headed swash plate-type compressor includes a cylinder block forming a swash plate chamber, a cylinder head comprising a front head, which is installed in front of the cylinder block, and a rear head, which is installed behind the same, and which has a discharge chamber formed therein such that a refrigerant is discharged, an oil separation unit, which has a refrigerant inlet formed adjacent to the discharge chamber, and which is integrated with the rear head and is arranged to slope towards the lower side of the rear head, and an oil storage unit positioned on the lower end of the oil separation unit so as to provide a space in which oil separated from the oil separation unit is stored.

### REFERENCE TO RELATED APPLICATIONS

This application is a United States National Phase application of PCT/IB2016/054375 filed on Jul. 22, 2016, which claims priority to Korean Application No. 10-2015-0099978 filed on Jul. 14, 2015.

### TECHNICAL FIELD

The present invention relates to a double-headed swash plate-type compressor, and more particularly, to a double-headed swash plate-type compressor capable of improving oil separation efficiency by optimally separating oil from a refrigerant, which flows via a discharge chamber to an oil separation unit, and of having a compact overall size.

### BACKGROUND ART

In general, a compressor serving to compress a refrigerant in a vehicle cooling system has been developed in various forms. The compressor includes a reciprocating compressor that compresses a refrigerant during reciprocation and a rotary compressor that compresses a refrigerant during rotation.

The reciprocating compressor includes a crank-type compressor that transmits driving force from a drive source to a plurality of pistons using a crank, a swash plate-type compressor that transmits driving force from a drive source to a rotary shaft equipped with a swash plate, and a wobble plate-type compressor that uses a wobble plate. The rotary compressor includes a vane rotary compressor that uses a rotary shaft and a vane and a scroll compressor that uses an orbiting scroll and a fixed scroll.

The swash plate-type compressor includes a fixed capacity swash plate-type compressor configured such that an installation angle of a swash plate is fixed and a variable capacity swash plate-type compressor configured such that an inclined angle of a swash plate varies to change a discharge capacity.

In these various compressors, a driving part is lubricated with oil, and the oil is mixed with a refrigerant. Accordingly, such a compressor necessarily includes an oil separator that separates only oil from a refrigerant at the discharge side thereof to resupply the oil to a driving part.

A conventional swash plate-type compressor includes an oil separator installed thereto, a housing including the oil separator, a cylinder block that has a plurality of cylinder bores and is coupled to the housing, a drive shaft that is installed rotatably to the cylinder block, and a swash plate that is installed so as to be rotatable by the drive shaft.

The swash plate-type compressor also includes an oil separation chamber into which a discharged refrigerant is introduced, the oil separator that is installed in the oil separation chamber, and an oil discharge passage through which oil separated from the refrigerant by the oil separator is supplied to a crank chamber having the swash plate installed therein. In the swash plate-type compressor, the discharged refrigerant containing the oil is introduced into the oil separation chamber so that the oil separated by centrifugal force remains in the inner peripheral surface of the oil separation chamber, and the oil remaining in the inner peripheral surface of the oil separation chamber is supplied to the crank chamber through the oil discharge passage.

In this case, an oil separation assembly necessarily includes an oil separator that separates an oil component from a refrigerant. Since the oil separation performance of the oil separator is determined according to the length of the oil separator, the length of the oil separator is preferably as long as possible.

However, the conventional swash plate-type compressor having the above structure includes the oil separation assembly together with the cylinder block having the plurality of cylinder bores radially arranged. Hence, there are many limitations on setting the length of the oil separator to be long.

When the oil separation assembly is, for example, installed at the upper portion of the cylinder block, the oil separator may have a limited length to avoid interference with the cylinder bores. In contrast, if the oil separator is set to have a long length, it may cause interference with other parts due to an excessive increase in overall volume of the swash plate-type compressor.

That is, since the conventional swash plate-type compressor has limitations on package, the length of the oils separator should be set to be short in the oil separation assembly, resulting in a deterioration in oil separation performance. For this reason, the driving part may not be lubricated with satisfaction.

### DISCLOSURE

### Technical Problem

Accordingly, the present invention has been made in view of the above-mentioned problems, and an object thereof is to provide a double-headed swash plate-type compressor capable of improving separation efficiency of oil contained in a refrigerant by obliquely disposing an oil separation unit in a rear head of the double-headed swash plate-type compressor and opening a refrigerant inlet toward the oil separation unit in a state in which the refrigerant inlet is inclined at a specific angle of inclination.

### Technical Solution

In accordance with an aspect of the present invention, a double-headed swash plate-type compressor includes a cylinder block (100) forming a swash plate chamber, a cylinder head (200) including a front head (210) installed in front of the cylinder block (100), and a rear head (230) installed behind the cylinder block (100) and having a discharge chamber (232) formed therein for discharge of a refrigerant. An oil separation unit (300) having a refrigerant inlet (302) is formed adjacent to the discharge chamber (232), the oil separation unit (300) being integrated with the rear head (230) while being inclined downward of the rear head (230). An oil storage unit (400) is positioned at a lower end of the oil separation unit (300) to provide a space for storage of oil separated by the oil separation unit (300).

The oil separation unit (300) may have a hollow cylindrical shape in an internal region thereof which communicates with the refrigerant inlet (302).

The oil separation unit (300) may include an inclined part (306) formed at the lower end thereof for connection with the oil storage unit (400), the inclined part (306) being reduced in diameter toward the oil storage unit (400), and an extension part (308) extending with a certain diameter from the inclined part (306) to the oil storage unit (400).

The refrigerant inlet (302) may be open at a side of the oil separation unit (300).

The refrigerant inlet (302) may be positioned at an intermediate upper side of the oil separation unit (300) in a longitudinal direction thereof.

The refrigerant inlet (302) may be open inward of the oil separation unit (300) and be inclined at a first angle of inclination (01).

The first angle of inclination (01) may be any one of 5° to 20°.

The refrigerant inlet (302) may have an opening diameter of 5 mm to 7 mm.

The oil storage unit (400) may extend horizontally on a side of the rear head (230).

The oil storage unit (400) may further include a cap (410) that is detachably coupled to one longitudinal end thereof, the cap (410) communicating with the lower end of the oil separation unit (300) and having a hollow cylindrical shape in an internal region thereof.

An oil return groove (10) may be formed between the oil storage unit (400) and the rear head (230) in order to supply the oil stored in the oil storage unit (400) to the swash plate chamber, and an orifice (20) may be installed in the oil return groove (10).

The oil return groove (10) may be disposed on an extension of the extension part (308).

The orifice (20) may be disposed on an extension orthogonal to an axial direction of the oil storage unit (400).

The oil return groove (10) may communicate with a lower side of the oil storage unit (400) and may extend horizontally.

The oil storage unit (400) may be disposed such that one end thereof is inclined upward.

The oil separation unit (300) may be inclined at an angle of 45° or more to the oil storage unit (400).

### Advantageous Effects

In accordance with exemplary embodiments of the present invention, it is possible to efficiently separate oil from a refrigerant by opening a refrigerant inlet at a specific angle of inclination toward an oil separation unit of a double-headed swash plate-type compressor and to achieve an improvement in compression efficiency and stable lubrication in the double-headed swash plate-type compressor by stably resupplying the oil to a swash plate chamber.

In the exemplary embodiments of the present invention, the double-headed swash plate-type compressor can have a compact overall size since oil required to operate the double-headed swash plate-type compressor is stably separated. Therefore, it is possible to stably operate the double-headed swash plate-type compressor while minimizing space constraints for installation.

### BRIEF DESCRIPTION OF DRAWINGS

FIG. 1 is a cross-sectional view illustrating a double-headed swash plate-type compressor according to an embodiment of the present invention.

FIG. 2 is a perspective view illustrating the double-headed swash plate-type compressor according to the embodiment of the present invention.

FIG. 3 is a view illustrating a discharge chamber included in the double-headed swash plate-type compressor according to the embodiment of the present invention.

FIG. 4 is a view illustrating an oil separation unit and an oil storage unit in the double-headed swash plate-type compressor according to the embodiment of the present invention.

FIG. 5 is a view illustrating an oil separation unit and an oil storage unit in a double-headed swash plate-type compressor according to another embodiment of the present invention.

### BEST MODE FOR INVENTION

Reference will now be made in detail to various embodiments of the present invention, examples of which are illustrated in the accompanying drawings and described below. The present invention may, however, be embodied in different forms and should not be construed as limited to the embodiments set forth herein. The present invention is intended to cover not only the exemplary embodiments, but also various alternatives, modifications, equivalents, replacements and other embodiments, which may be included within the spirit and scope of the present invention as defined by the appended claims. In the drawings, the thickness of each line or the size of each component may be exaggerated or schematically illustrated for convenience of description and clarity.

In addition, the terms used in the specification are terms defined in consideration of functions in the present invention, and these terms may vary with the intention or practice of a user or an operator. Therefore, these terms should be defined based on the entire content disclosed herein.

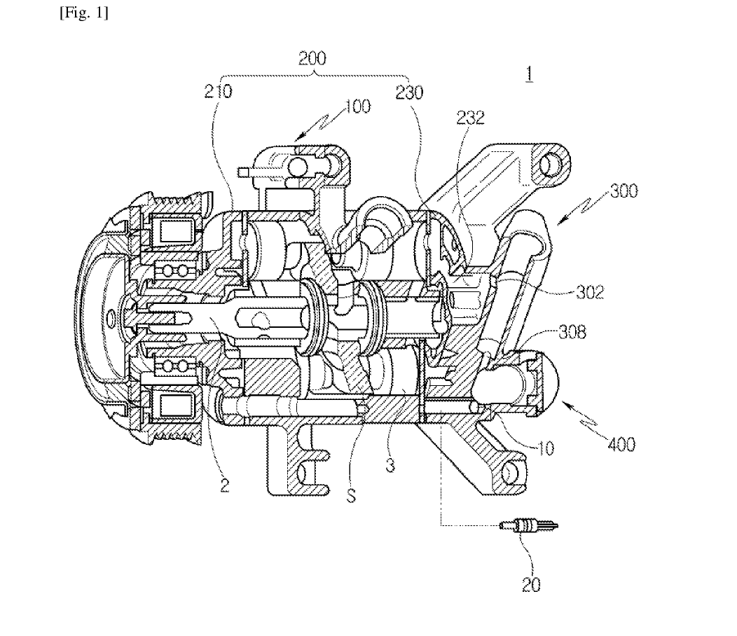

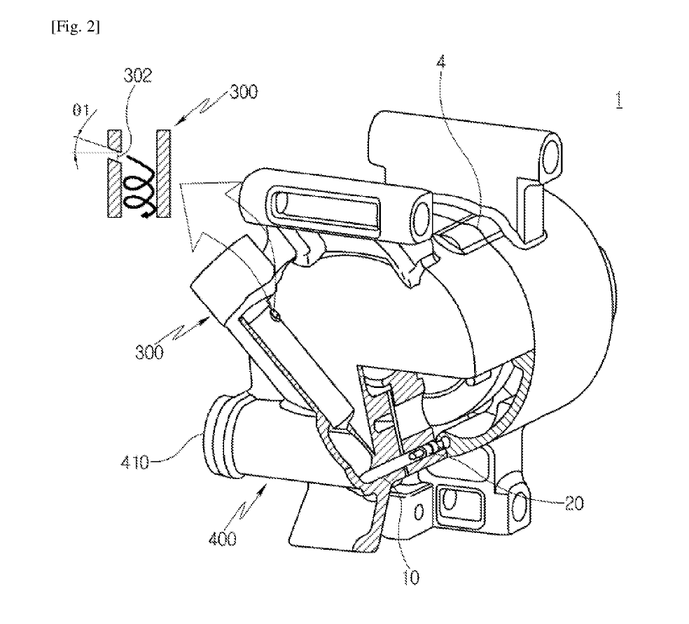

Hereinafter, exemplary embodiments of the present invention will be described in detail with reference to the accompanying drawings. For reference, FIG. 1 is a cross-sectional view illustrating a double-headed swash plate-type compressor according to an embodiment of the present invention, and FIG. 2 is a perspective view illustrating the double-headed swash plate-type compressor according to the embodiment of the present invention.

Referring to FIGS. 1 and 2, the double-headed swash plate-type compressor, which is designated by reference numeral 1, according to the embodiment of the present invention includes a cylinder block 100, a cylinder head 200 including a front head 210 and a rear head 230, an oil separation unit 300, and an oil storage unit 400.

The cylinder block 100 is a component that defines the external appearance of the double-headed swash plate-type compressor. A shaft 2 is installed at the center in the cylinder block 100 so as to be rotatable by driving force transmitted from the outside, and a swash plate S is inserted into the cylinder block 100 in the axial direction of the shaft 2 to compress a refrigerant.

The cylinder block 100 has a swash plate chamber formed therein and has a plurality of cylinder bores that are circumferentially arranged to surround the shaft 2. A piston 3 is disposed in each of the cylinder bores. The piston 3 compresses a refrigerant while longitudinally moving in the associated cylinder bore along with the rotation of the shaft 2.

The cylinder block 100 has a refrigerant flow passage 4 (see FIG. 2) formed therein for supply of the compressed refrigerant to the rear head 230 of the cylinder head 200 so that the compressed refrigerant stably flows through the refrigerant flow passage 4 according to movement of the piston 3.

The cylinder head 200 includes the front head 210 that is installed in front of the cylinder block 100, and the rear head 230 that is installed behind the cylinder block 100 and has a discharge chamber 232 formed therein for discharge of a refrigerant.

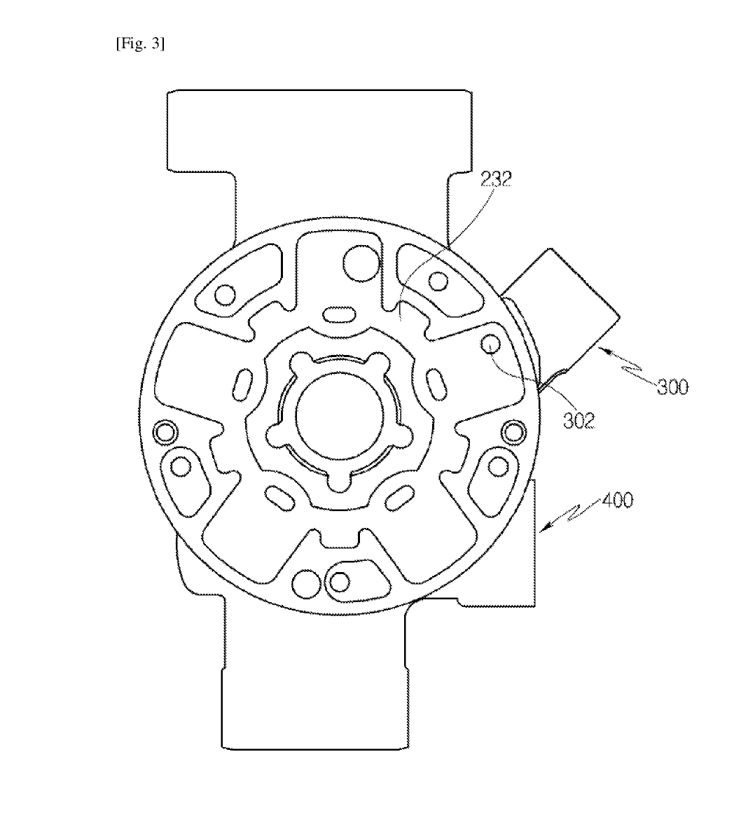

The oil separation unit 300 has a refrigerant inlet 302 that is formed adjacent to the discharge chamber 232 (see FIG. 3). The oil separation unit 300 is integrated with the rear head 230 while obliquely extending downward of the rear head 230, and the lower end of the oil separation unit 300 communicates with the oil storage unit 400.

The oil separation unit 300 has a hollow cylindrical shape therein for separation of oil from a refrigerant and communicates with the upper surface of the oil storage unit 400 such that the separated oil flows to the oil storage unit 400 positioned at the lower end of the oil separation unit 300.

The refrigerant inlet 302 is formed to be open at the intermediate upper side of the oil separation unit 300 in the longitudinal direction thereof. The refrigerant inlet 302 is disposed at the intermediate upper side of the oil separation unit 300 such that a refrigerant flows downward in a state in which the rotational force of the oil separation unit 300 is maintained at a predetermined speed in an inward circumferential direction when the refrigerant flows inward of the oil separation unit 300 from the discharge chamber 232.

Especially, a refrigerant is discharged at a predetermined pressure from the refrigerant inlet 302 to an internal region of the oil separation unit 300. In this case, since the refrigerant inlet 302 is positioned at the intermediate upper side of the oil separation unit 300, the rotational force of the oil separation unit 300 is stably maintained while the refrigerant flows along the inner peripheral surface of the oil separation unit 300 in the downward longitudinal direction thereof, thereby easily separating oil from the refrigerant.

The refrigerant inlet 302 is open at the side of the oil separation unit 300 so that a refrigerant is discharged along the side of the oil separation unit 300 rather than the center thereof with respect to the inner surface of the oil separation unit 300. Thus, it is possible to easily separate oil from the refrigerant flowing in the longitudinal direction of the oil separation unit 300.

The refrigerant inlet 302 is open inward of the oil separation unit 300 and is inclined at a first angle of inclination θ1. Here, the first angle of inclination θ1 means an angle at which the refrigerant inlet 302 opened inward of the oil separation unit 300 is inclined downward in the oil separation unit 300.

The first angle of inclination θ1 may be any one of 5° to 20° and will be described with reference to the following Table 1.

TABLE 1

| Angle | Oil Separation Efficiency |
|---|---|
| 0 | 42.3 |
| 5 | 50 |
| 10 | 51 |
| 15 | 55 |
| 20 | 51 |
| 25 | 49.3 |
| 30 | 47.1 |

Referring to Table 1, the first angle of inclination θ1 of the refrigerant inlet 302 is tested from 0° to 30° under the condition that the double-headed swash plate-type compressor is operated at 800 RPM, Pd/Td is 19 kgf/cm² G/90° C., and OIC is 3%.

The separation efficiency of oil contained in a refrigerant is measured to be 42.3% when the first angle of inclination θ1 of the refrigerant inlet 302 is 0°, and the oil separation efficiency is measured to be 50% or more when the first angle of inclination θ1 is from 5° to 20°.

In particular, according to the test result, when the first angle of inclination θ1 is 20° or more, it is not preferable to separate oil from a refrigerant since the oil contained in the refrigerant flows to a discharge port (not shown) from the lower portion of the oil separation unit 300.

On the other hand, when the first angle of inclination θ1 of the refrigerant inlet 302 is one of 5°, 10°, 15°, and 20°, it can be seen that the separation efficiency of oil contained in a refrigerant is stably maintained.

As such, when the separation efficiency of oil contained in a refrigerant is maintained at 50% or more, it is possible to improve refrigerant compression performance and minimize abrasion and heat generation due to friction since oil is stably supplied according to the movement of the piston 3.

For reference, the oil separation efficiency is best when the first angle of inclination θ1 is 15°. Although the refrigerant inlet 302 is preferably open at a first angle of inclination θ1 of 15°, it can be open at one of the above-mentioned angles.

The refrigerant inlet 302 has an opening diameter of 5 mm to 7 mm. When the refrigerant inlet 302 has an opening diameter of 5 mm or less, the rate of discharge of a refrigerant to the internal region of the oil separation unit 300 may be increased due to the reduction in opening diameter of the refrigerant inlet 302, and the flow rate of the refrigerant may be increased in the longitudinal direction of the oil separation unit 300. Hence, the separation efficiency of oil contained in a refrigerant may be deteriorated.

On the other hand, when the refrigerant inlet 302 has an opening diameter of 7 mm or more, the rate of discharge of a refrigerant to the internal region of the oil separation unit 300 is decreased compared to when the refrigerant inlet 302 has an opening diameter of 5 mm or less, but the oil separation efficiency is relatively reduced compared to that in the range of the above-mentioned opening diameter. Therefore, it is most preferable that the refrigerant inlet 302 has an opening diameter of 5 mm to 7 mm.

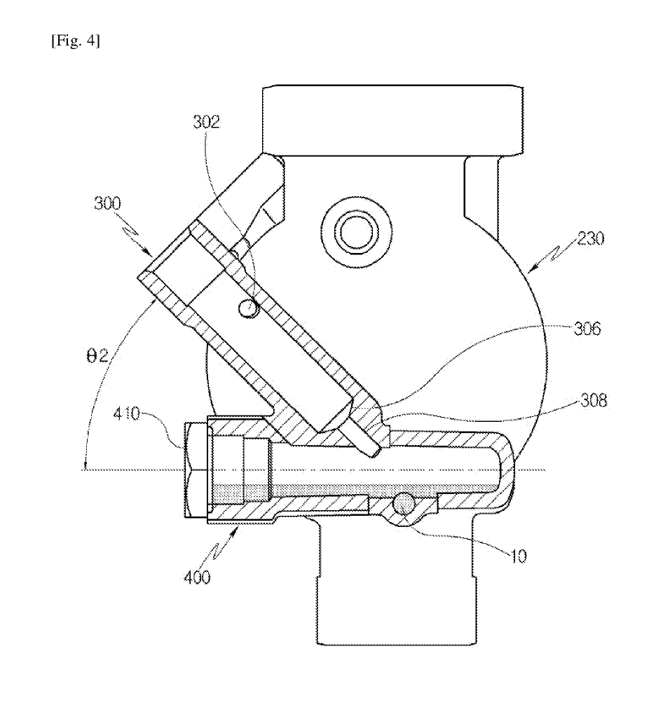

Referring to FIGS. 3 and 4, the oil separation unit 300 includes an inclined part 306 that is formed at the lower end thereof for connection with the oil storage unit 400 and is reduced in diameter toward the oil storage unit 400 and an extension part 308 that extends with a certain diameter from the inclined part 306 to the oil storage unit 400.

The inclined part 306 is reduced in diameter in the longitudinal downward direction thereof, as illustrated in the drawings. Therefore, after the oil contained in the refrigerant flows along the inner peripheral surface of the oil separation unit 300, it is stably collected toward the center of the inclined part 306. Then, the oil may stably flow to the oil storage unit 400 through the extension part 308.

The oil storage unit 400 is positioned at the lower end of the oil separation unit 300 and provides a space for storage of oil separated by the oil separation unit 300. By way of example, the oil storage unit 400 extends horizontally on the side of the rear head 230.

The oil storage unit 400 has a hollow therein to provide a space for storage of a large amount of oil. By way of example, the oil storage unit 400 includes a cap 410 that is detachably installed to one longitudinal end thereof, and the cap 410 has a hollow cylindrical shape in the internal region thereof.

The oil storage unit 400 may extends to have a length similar to the diameter of the rear head 230. In this case, since the oil storage unit 400 protrudes to a minimum outward of the rear head 230, it is possible to reduce an influence on the layout of installation place when the double-headed swash plate-type compressor is installed in a vehicle.

Accordingly, since oil contained in a refrigerant is stably stored and the volume of the double-headed swash plate-type compressor according to installation is minimized, it is possible to improve utilization of installation space.

Since the oil storage unit 400 is horizontally disposed, the surface of oil flowing through the extension part 308 is horizontally maintained and the oil is stably supplied through an orifice 20 to be described later.

The cap 410 may be bolted to the oil storage unit 400 for easy attachment and detachment. In this case, the oil storage unit 400 has a thread formed on the inner surface thereof for easy coupling of the cap 410. Thus, an operator may easily install the cap 410 to the oil storage unit 400 and periodically decouple the cap 410 therefrom to inspect the oil storage unit 400 and check the internal state thereof. Therefore, the oil storage unit 400 can be maintained and managed such that oil is uniformly supplied to the orifice 20 according to the precipitation of oil or the accumulation of foreign substances.

The oil separation unit 300 is disposed at a second angle of inclination θ2 such that it is inclined to the oil storage unit 400 at angle of 45° or more. Here, the second angle of inclination θ2 means an angle formed between the oil separation unit 300 inclined toward the rear head 230 and the oil storage unit 400 horizontally disposed at the lower side of the rear head 230.

When the oil separation unit 300 is inclined at an angle of inclination of 45° or more, oil contained in a refrigerant may stably flow toward the oil storage unit 400. Therefore, the arrangement of the oil separation unit 300 at the angle of inclination is effective in improving the oil separation efficiency of the double-headed swash plate-type compressor.

An oil return groove 10 is formed between the oil storage unit 400 and the rear head 230 in order to supply the oil stored in the oil storage unit 400 to the rear head 230, and the orifice 20 is installed in the oil return groove 10.

Since the oil return groove 10 communicates with the lower side of the oil storage unit 400 and extends horizontally, the oil stored in the oil storage unit 400 stably flows to the orifice 20. Thus, it is possible to stably supply oil required to operation the double-headed swash plate-type compressor and improve supply of oil.

Since the oil return groove 10 is disposed on the extension of the extension part 308, the oil flowing through the extension part 308 may stably flow through the oil return groove 10. In addition, since the flow path of oil to the oil return groove 10 is maintained at the shortest distance, it is possible to simplify the flow path.

The orifice 20 allows an amount of oil flowing to the swash plate chamber to be uniform for stable operation of the piston 3. The orifice 20 is disposed on the extension orthogonal to the axial direction of the oil storage unit 400, and the oil stored in the oil storage unit 400 drops on the extension of the orifice 20. Therefore, the oil flows at the shortest distance toward the orifice 20 via the oil return groove 10.

Since the orifice 20 is inserted into the oil return groove 10 and communicates with an inlet (not shown) of the orifice 20, the oil stably flows via the orifice 20.

An oil storage unit according to another embodiment of the present invention will be described with reference to the accompanying drawing.

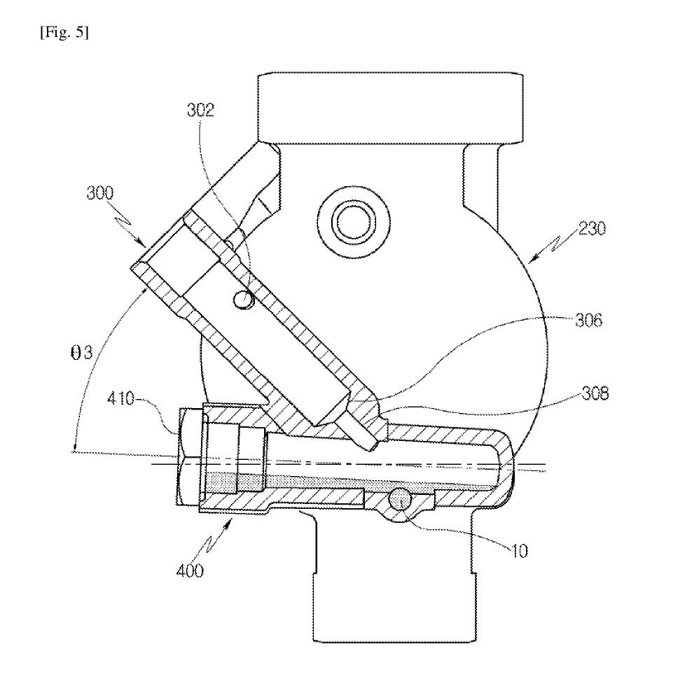

Referring to FIG. 5, the oil storage unit, which is designated by reference numeral 400, may be disposed in a state in which one end thereof (the left in the drawing) is inclined toward the upper side thereof at a third angle of inclination θ3, and the third angle of inclination θ3 means an angle formed between an oil separation unit 300 inclined to a rear head 230 and the oil storage unit 400 inclined left upward in the drawing from the lower side of the rear head 230.

When the oil storage unit 400 is disposed in such a state, oil separated by the oil separation unit 300 is collected in an oil return groove 10 formed opposite to a cap 410. In this case, since the oil is always positioned at the lower side of the inclined oil storage unit 400, it is possible to stably supply oil to an orifice 20 via the oil return groove 10.

Accordingly, it is possible to reduce a state in which oil is collected in the oil storage unit 400 without return to a swash plate chamber.

Although the present invention has been described with respect to the illustrative embodiments, it will be apparent to those skilled in the art that various variations and modifications may be made without departing from the spirit and scope of the invention as defined in the following claims.

### INDUSTRIAL APPLICABILITY

The present invention has been made in view of the above-mentioned problems, and is to provide a double-headed swash plate-type compressor capable of improving separation efficiency of oil contained in a refrigerant, by obliquely disposing an oil separation unit in a rear head of the double-headed swash plate-type compressor and opening a refrigerant inlet toward the oil separation unit in a state in which the refrigerant inlet is inclined at a specific angle of inclination.

In accordance with exemplary embodiments of the present invention, it is possible to efficiently separate the oil from the refrigerant by opening the refrigerant inlet at a specific angle of inclination toward the oil separation unit of the double-headed swash plate-type compressor, and to achieve an improvement in compression efficiency and stable lubrication in the double-headed swash plate-type compressor by stably resupplying the oil to a swash plate chamber.

In the exemplary embodiments of the present invention, the double-headed swash plate-type compressor can have a compact overall size since the oil required to operate the double-headed swash plate-type compressor is stably separated. Therefore, it is possible to stably operate the double-headed swash plate-type compressor while minimizing space constraints for installation.

1. A double-headed swash plate-type compressor comprising:
a cylinder block forming a swash plate chamber;
a cylinder head comprising a front head installed in front of the cylinder block, and a rear head installed behind the cylinder block and having a discharge chamber formed therein for discharge of a refrigerant;
an oil separation unit having a refrigerant inlet formed adjacent to the discharge chamber, the oil separation unit being integrated with the rear head while being inclined downward of the rear head; and
an oil storage unit positioned at a lower end of the oil separation unit to provide a space for storage of oil separated by the oil separation unit.

2. The double-headed swash plate-type compressor according to claim 1, wherein the oil separation unit has a hollow cylindrical shape in an internal region thereof which communicates with the refrigerant inlet.

3. The double-headed swash plate-type compressor according to claim 1, wherein the oil separation unit comprises an inclined part formed at the lower end thereof for connection with the oil storage unit, the inclined part being reduced in diameter toward the oil storage unit and an extension part (308) extending with a certain diameter from the inclined part to the oil storage unit.

4. The double-headed swash plate-type compressor according to claim 1, wherein the refrigerant inlet is open at a side of the oil separation unit.

5. The double-headed swash plate-type compressor according to claim 1, wherein the refrigerant inlet is positioned at an intermediate upper side of the oil separation unit in a longitudinal direction thereof.

6. The double-headed swash plate-type compressor according to claim 1, wherein the refrigerant inlet is open inward of the oil separation unit and is inclined at a first angle of inclination.

7. The double-headed swash plate-type compressor according to claim 6, wherein the first angle of inclination is any one of 5° to 20°.

8. The double-headed swash plate-type compressor according to claim 1, wherein the refrigerant inlet has an opening diameter of 5 mm to 7 mm.

9. The double-headed swash plate-type compressor according to claim 1, wherein the oil storage unit extends horizontally on a side of the rear head.

10. The double-headed swash plate-type compressor according to claim 1, wherein the oil storage unit further comprises a cap that is detachably coupled to one longitudinal end thereof, the cap communicating with the lower end of the oil separation unit and having a hollow cylindrical shape in an internal region thereof.

11. The double-headed swash plate-type compressor according to claim 3, wherein an oil return groove is formed between the oil storage unit and the rear head in order to supply the oil stored in the oil storage unit to the swash plate chamber, and an orifice is installed in the oil return groove.

12. The double-headed swash plate-type compressor according to claim 11, wherein the oil return groove is disposed on an extension of the extension part.

13. The double-headed swash plate-type compressor according to claim 11, wherein the orifice is disposed on an extension orthogonal to an axial direction of the oil storage unit.

14. The double-headed swash plate-type compressor according to claim 11, wherein the oil return groove communicates with a lower side of the oil storage unit and extends horizontally.

15. The double-headed swash plate-type compressor according to claim 10, wherein the oil storage unit is disposed such that one end thereof is inclined upward.

16. The double-headed swash plate-type compressor according to claim 1, wherein the oil separation unit is inclined at an angle of 45° or more to the oil storage unit.
